(19) United States
(12) Patent Application Publication
(10) Pub. No.: US 2010/0041533 A1
(43) Pub. Date: Feb. 18, 2010

(54) APPARATUS AND METHOD FOR BALANCING A CYLINDER ROLL

(76) Inventors: Charles TREMBLAY, La Baie (CA); Martin BERGERON, Shipshaw (CA); Martin SIMARD, La Baie (CA); Michel JULIEN, Tewkesbury (CA)

Correspondence Address: LADAS & PARRY LLP, 224 SOUTH MICHIGAN AVENUE, SUITE 1600, CHICAGO, IL, 60604, US

(21) Appl. No.: 12/539,365

(22) Filed: Aug. 11, 2009

Related U.S. Application Data
(60) Provisional application No. 61/136,082, filed on Aug. 11, 2008.

(51) Int. Cl. F16F 15/32; F16C 13/00; B23P 11/00

(52) U.S. Cl. 492/6; 492/60; 29/895.2

(57) ABSTRACT

An apparatus for balancing a tubular cylinder roll having an inner annular face comprises an annular body defining inner and outer faces. These annular body is outwardly biased so as to provide the outer face thereof to sufficiently engage the inner annular face of the tubular cylinder roll so as to stay in position. Weight receiving elements are disposed on the inner face of the annular body for removably receiving balance weights. When the apparatus is mounted to the cylinder roll, the balance weights can be selectively and removably mounted thereto thereby balancing the cylinder roll.

### CROSS-REFERENCE TO OTHER APPLICATIONS

The present application requests priority on U.S. Provisional Application No. 61/136,082 filed on Aug. 11, 2008 and incorporated herein by reference in its entirety.

### FIELD OF THE INVENTION

The present invention relates to cylinder rolls used in processing machines in the pulp, paper, textile and plastic industries for example. More specifically but not exclusively, the present invention is concerned with an apparatus and method for balancing a cylinder roll.

### BACKGROUND OF THE INVENTION

Cylinder rolls used in processing machines, such as drying cylinders used in the pulp and paper industry as well as other devices used in the textile and plastic industries become oval during rotation. The foregoing is known as the whip effect. This problem is aggravated when rotational speed is increased. Various systems have intended to overcome this problem by balancing the cylinder rolls so as to avoid this deformation.

Some improved systems have provided annular rails within the body of the cylinder roll, fixed to the inner face thereof with a balance weight being attached to the rails.

A drawback of known systems is that they do not provide for the weight to be easily adjusted. A drawback of known systems is that annular devices are fastened to the inner faces of the cylinder tubes.

### OBJECTS OF THE INVENTION

An object of the present invention is to provide an apparatus for balancing a cylinder roll

An object of the present invention is to provide a cylinder roll.

An object of the present invention is to provide a method for balancing a cylinder roll.

### SUMMARY OF THE INVENTION

In accordance with an aspect of the present invention, there is provided an apparatus for balancing a rotatable tubular cylinder roll having an inner annular face, the apparatus comprising:

an annular body for being positioned within the cylinder roll and defining inner and outer faces, the outer face engaging the cylinder inner annular face; and

weight receiving elements disposed on the inner face of the annular body for receiving balance weights,

wherein when the apparatus is mounted to the cylinder roll, the balance weights can be selectively and removably mounted thereto for balancing the cylinder roll during rotation thereof.

In an embodiment, the annular body is outwardly biased thereby providing the outer face to sealingly engage the cylinder inner annular face. In an embodiment, the size of the annular body is selectively modifiable. In an embodiment, the annular body size is modifiable by an adjustment assembly mounted thereto. In an embodiment, the annular body size is modifiable between one position where it sealingly engages the cylinder inner annular face and another position where it disengages the cylinder inner annular face. In an embodiment, the annular body comprises a pair of adjacent free ends. In an embodiment, an adjustable fastening assembly is fastened to the adjacent free ends for adjusting the distance between the free ends for selectively modifying the size of the annular body.

In an embodiment, the weight receiving elements and the balance weights comprise mutual fasteners. In an embodiment, the weight receiving elements comprise tubes, the balance weights comprise rods, the tubes comprising an open end for receiving a respective rod, the tube comprising a removable cap at an opposite end thereof, the cap comprising a fastener to fastened to fastener receiving element at a longitudinal end of the rod adjacent the cap.

In accordance with an aspect of the present invention, there is provided a rotatable tubular cylinder roll comprising:

an inner annular face; and

weight receiving tubes disposed on the inner face of the annular body for receiving balance weights,

wherein balance weights are selectively and removably mounted to the weight receiving tubes for balancing the cylinder roll during rotation thereof.

In accordance with an aspect of the present invention, there is provided a rotatable tubular cylinder roll comprising:

an inner annular face;

an apparatus for balancing a rotatable tubular cylinder roll having an inner annular face, the apparatus comprising:

an annular body mounted within the cylinder roll and defining inner and outer faces, the outer face engaging the cylinder inner annular face; and weight receiving elements disposed on the inner face of the annular body for receiving balance weights,

wherein the balance weights are selectively and removably mounted to the apparatus for balancing the cylinder roll during rotation thereof.

In accordance with the present invention, there is provided a method for balancing a cylinder roll, the method comprising:

providing an outwardly and annularly biased body to securely engage the inner annular face of the cylinder roll; and

mounting balance weights to this body.

Other objects, advantages and features of the present invention will become more apparent upon reading of the following non-restrictive description of illustrative embodiments thereof given by way of example only with reference to the accompanying drawings.

### BRIEF DESCRIPTION OF THE DRAWINGS

In the appended drawings, where like reference numerals denote like elements throughout, and where:

FIG. 1 is a perspective view of a cylinder roll in accordance with a non-limiting illustrative embodiment of the present invention;

FIGS. 2a and 2b and 2c are perspective views of the balancing apparatus for cylinder rolls in accordance with a non-limiting illustrative embodiment of the present invention;

FIG. 2c is a perspective view of the balancing apparatus for cylinder rolls in accordance with another non-limiting illustrative embodiment of the present invention;

FIG. 3 is a perspective view of the balancing apparatus cylinder rolls of FIGS. 2a-2b mounted to a cylinder roll;

FIG. 4 is a front elevational view of the balancing apparatus for cylinder rolls of FIGS. 2a-2b;

FIG. 5 is a side elavational view of the balancing apparatus for cylinder rolls of FIGS. 2a-2b;

FIGS. 6 is a perspective view of a weight-receiving element in accordance with a non-limiting illustrative embodiment of the present invention;

FIG. 7 is a sectional view of the weight-receiving element of FIG. 6;

FIG. 8 is a perspective view of a balance weight in accordance with a non-limiting illustrative embodiment of the present invention; and

FIG. 9 is a sectional view of the balance weight of FIG. 5a.

### DETAILED DESCRIPTION OF ILLUSTRATIVE EMBODIMENTS

Generally stated the invention provides, in one embodiment thereof, an apparatus that includes an annular band for being fitted within a cylinder roll. The annular band is cut thereby forming two adjacent free ends and is outwardly biased. The outer face of the annular band engages the inner face of the cylinder roll and the tension of the outwardly biasing force maintains it in place. The adjacent free ends are attached via an adjustable fastening assembly so as to adjust the size of the annular band. The inner face of the annular band includes with weight receiving elements for removable receiving balance weights.

With reference to the associated drawings embodiments of the present invention will now be described.

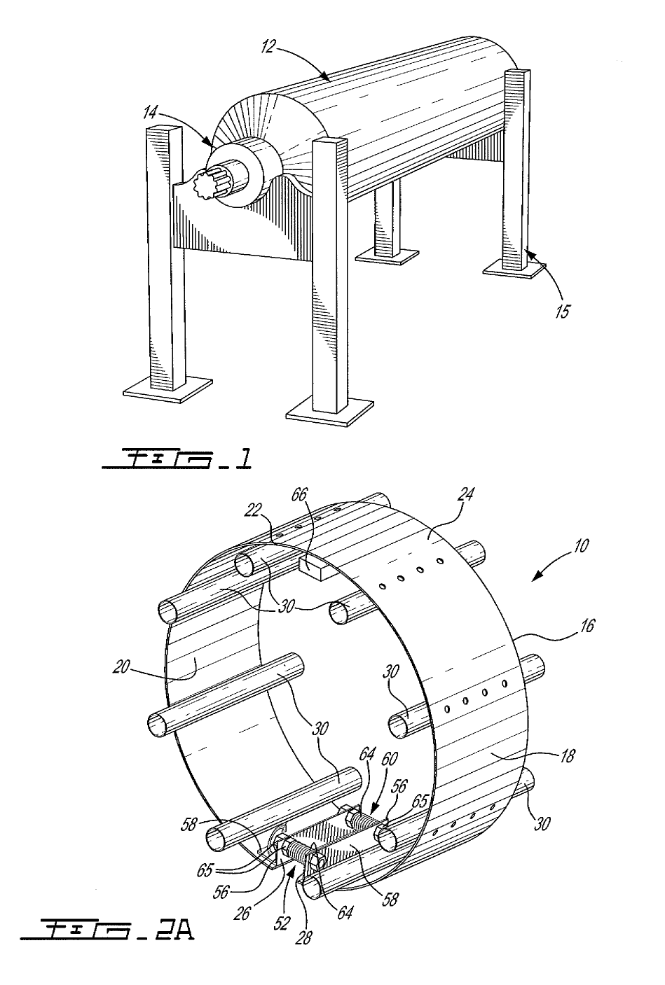

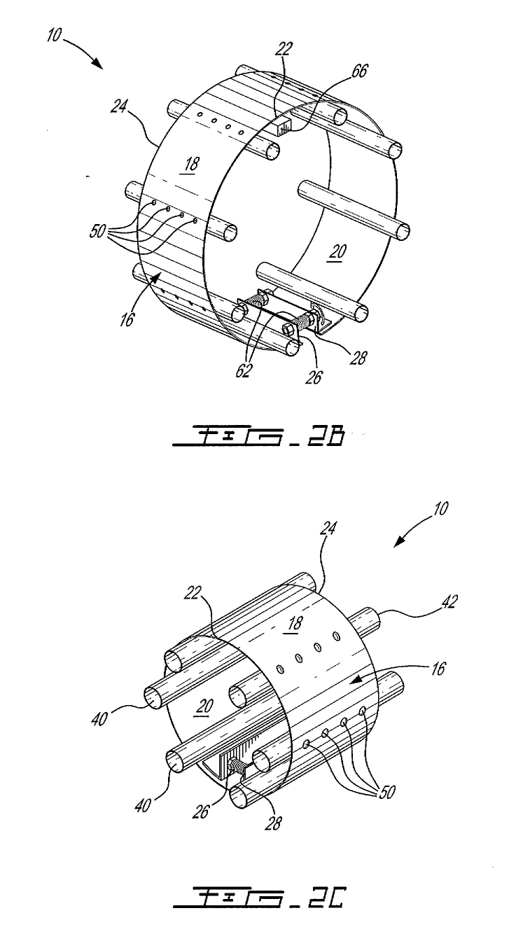

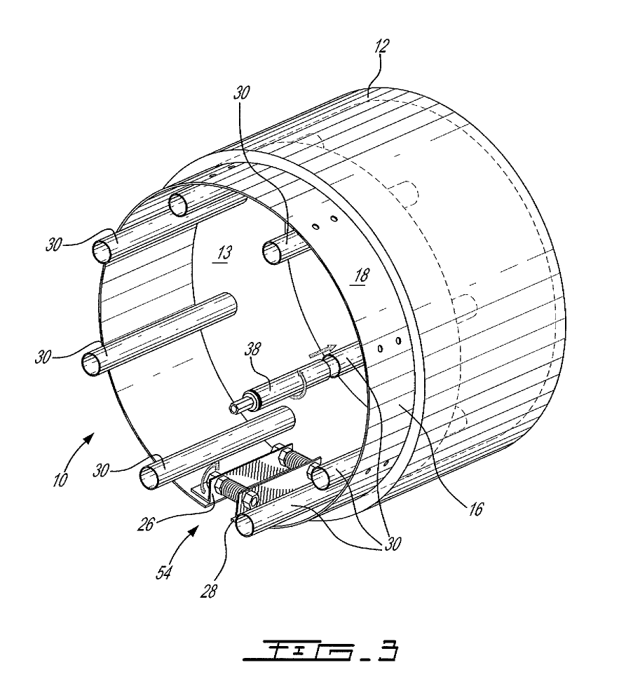

FIGS. 2a, 2b and 2C show a weight balancing apparatus 10 for cylinder roll 12, shown in FIG. 1. The cylinder roll 11 includes longitudinal body being mounted via shafts 14 qt it longitudinal ends to an actuating system 15 for rotation thereof. The body of the cylinder roll is tubular and as such provides a space for receiving weight balancing apparatuses 10.

Turning back to FIGS. 2a, 2b and 2c, the weight balancing apparatus 10 includes an annular band 16 having an outer surface 18 and an inner surface 20, a first side 22 and second side 24 as well as a pair of adjacent free ends 26 and 28. The weight balancing apparatus 10 of FIG. 2c includes a longer band 16 than the apparatuses of FIGS. 2a and 2b.

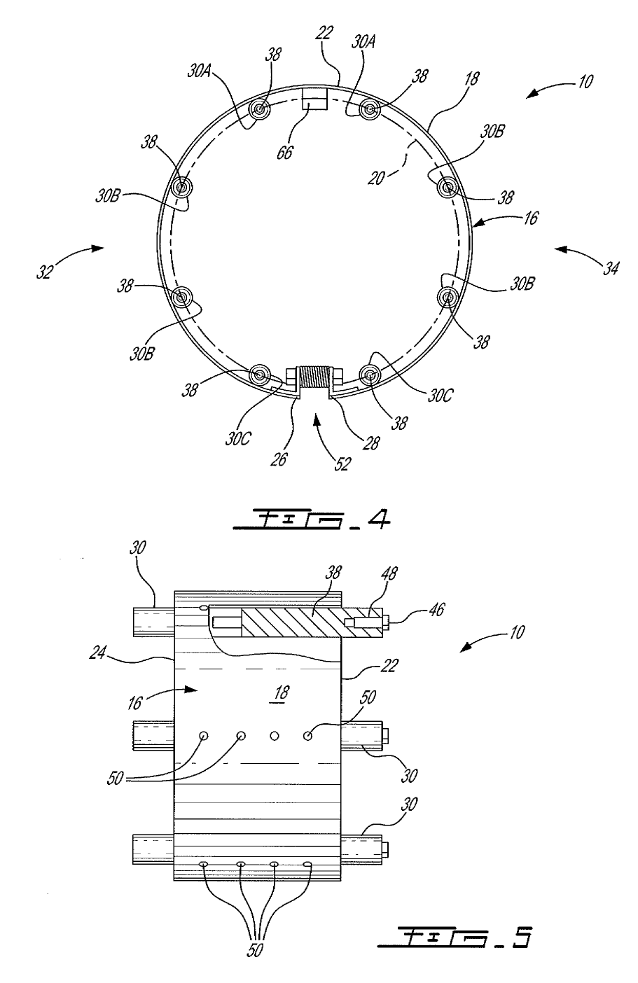

The inner surface 20 includes a plurality of weight receiving elements, generally denoted 30. In the illustrated example, the weight receiving elements are hollow tubes extending the full length the band 16 and protruding from the first and second sides 22 and 24. Again, in this example there are eight weight receiving tubes 30, more particularly and as shown in FIG. 4 there are two top weight receiving tubes 30A, a pair of weight receiving tubes 30B at each lateral side 32 and 34 of the band 16 and a pair of bottom weight receiving tubes 30C. The weight receiving tubes 30 are positioned at generally equal distances from each other. Of course, a greater or lesser number of differently configured weight receiving elements, being positioned at various strategic areas on the inner surface 18 of the band 16 can be contemplated within the scope of the present invention.

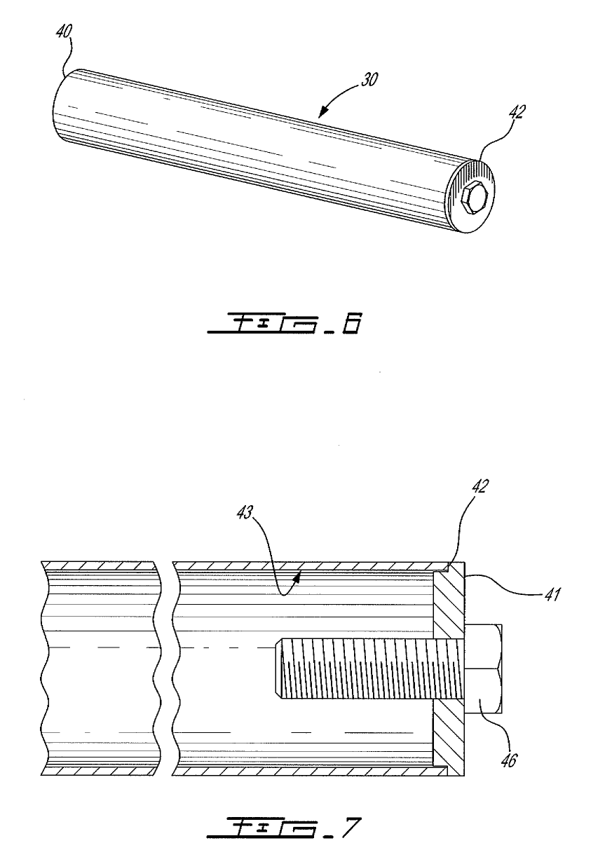

As shown in FIGS. 4, 5, 6 and 7, each weight receiving tube 30 is configured to removably receive a balance weight 38 therein. More specifically, and as shown in FIGS. 5, 6 and 7, each weight receiving tube 30 includes opposite longitudinal ends 40 and 42 with at least one end (40 in this example) being open for providing passage to the balance weight 38 to be fitted within the chamber 43 defined by the tube.

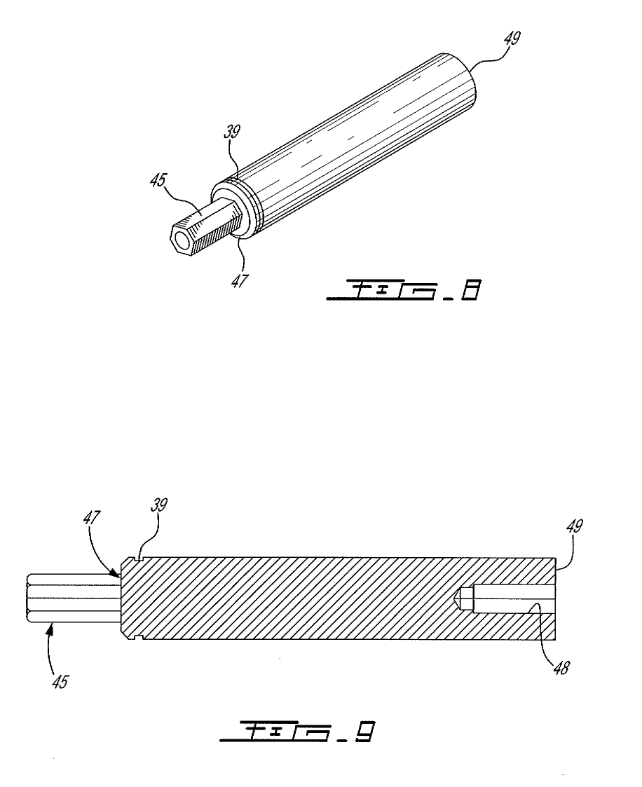

With reference to FIGS. 5, 8 and 9, the balance weights 38 are shown here to be in the form of rods that are placed within their respective weight receiving tubes 30. Of course a variety of differently and suitably configured balance weights can be contemplated within the scope of the present invention. In the non-limiting example here, the balance weight rod 38 fastened within a tube 30 via a fastener 46 that is integral to end 42 of the tube 30. In fact, the fastener 46 is mounted to a removable cap 41. Accordingly, the balance weight rod 38 includes a bore 48 at is end 49 for receiving the fastener 46. It is within the context of the present invention to fasten the balance weight rods 38 to their respective tubes 30 via other means as can be contemplated by a person having skill in the art. The opposite end 47 of the rod 38 includes a handle member 45 protruding therefrom which provides the user with handling the tube via a clamp. Finally the rod 38 includes a machined circular indentation 39 for receiving an O-ring.

The annular band 16 includes aligned openings 50 on its outer face 18 which are useful for welding the tubes 30 the inner surface 20. Of course, the tubes 30 can be mounted to the inner surface by other methods that the skilled artisan can contemplate within the scope of the present invention.

The annular band 16 has a cut 52, defining the adjacent free ends 26 and 28, and is so designed as to be outwardly biased. As such, the free ends 26 and 28 are fastened together via an adjustable fastening assembly 54. More specifically, the free ends 26 and 28 include respective bracket elements 56 (having receiving apertures 58 for receiving the fastening assembly 60. The fastening assembly 60 comprises a pair of bolts 62 (see FIG. 2b) carrying spring members 64, providing flexibility and resilience. The bolts 62 are fastened to the bracket 56 via nuts 65 which can adjust the distance between the free ends 26 and 28 by being loosened or tightened. Of course, a variety of adjustable fastening elements within the scope of the present invention can be contemplated by one having skill in the art.

The annular band 16 also includes a spine member 66 at its inner face 20 and opposite the cut 52. This spine member 66 provides stability to the band 16 against tension force for example.

With reference to FIG. 3, an apparatus 10 is mounted to the inner annular face 13 of a cylinder roll 12 by placing its outer face 18 flush within the inner annular face 13 of the cylinder roll 12. The apparatus 10 stays in place due to the tension force of the band 16 acting against the cylinder roll 12 inner face 13. Depending on the diameter of the cylinder roll 12, the band 16 will be adjusted by either being made smaller (i.e. tightening the fastening assembly 54 so as to bring the ends 26 and 28 closer together) or being made larger (i.e. loosening the fastening assembly 54 so as to allow the ends 26 and 28 to move further apart). Therefore, the skilled artisan can provide a proper tension force of the band 16 against the inner face 13 of the cylinder roll 12 so as to keep it in position.

In one embodiment, only one apparatus 10 is mounted to the 10 inner face of the cylinder roll 12. In one embodiment, the balance weights 38 can span the length of the cylinder roll 12.

In another embodiment, a plurality of apparatuses 10 is mounted to the inner face 13 of a cylinder roll 12. The balance weights 38 can span the length of the cylinder roll 12 and as such run from the tube 30 of one apparatus 10 to the corresponding tube 30 of the next apparatus and so on. Of course, the balance weights 38 can run trough a series of apparatus 10 that do not span the whole length of the cylinder roll 12. In another embodiment, each apparatus 10 has its own balance weights 38 that are fitted within its own receiving tubes 30.

The balancing apparatuses of the present invention provide for bringing the centre of gravity of the cylinder roll closer to its axis of rotation by positioning the balance weights 38 within the weight receiving elements 30.

It is to be understood that the invention is not limited in its application to the details of construction and parts illustrated in the accompanying drawings and described hereinabove. The invention is capable of other embodiments and of being practised in various ways. It is also to be understood that the phraseology or terminology used herein is for the purpose of description and not limitation. Hence, although the present invention has been described hereinabove by way of embodiments thereof, it can be modified, without departing from the spirit, scope and nature of the subject invention as defined in the appended claims.

What is claimed is:

1. An apparatus for balancing a rotatable tubular cylinder roll having an inner annular face, the apparatus comprising:
an annular body for being positioned within the cylinder roll and defining inner and outer faces, said outer face engaging the cylinder inner annular face; and
weight receiving elements disposed on the inner face of the annular body for receiving balance weights,
wherein when said apparatus is mounted to the cylinder roll, said balance weights can be selectively and removably mounted thereto for balancing the cylinder roll during rotation thereof.

2. An apparatus according to claim 1, wherein said annular body is outwardly biased thereby providing said outer face to sealingly engage the cylinder inner annular face.

3. An apparatus according to claim 2, wherein said annular comprises a spine member for providing stability thereto against the biasing force.

4. An apparatus according to claim 2, wherein the size of said annular body is selectively modifiable.

5. An apparatus according to claim 4, wherein said annular body size is modifiable by an adjustment assembly mounted thereto.

6. An apparatus according to claim 4, wherein said annular body size is modifiable between one position where it sealingly engages the cylinder inner annular face and another position where it disengages the cylinder inner annular face.

7. An apparatus according to claim 2, wherein said annular body comprises a pair of adjacent free ends.

8. An apparatus according to claim 7, wherein an adjustable fastening assembly is fastened to said adjacent free ends for adjusting the distance between said free ends for selectively modifying the size of said annular body.

9. An apparatus according to claim 8, wherein said adjustable fastening assembly comprises fasteners for being mounted to said free ends and carrying flexible and resilient elements.

10. An apparatus according to claim 1, wherein said annular body comprises a band defining first and second open sides, said first and second ends defining the length of said band therebetween.

11. An apparatus according to claim 10, wherein said weight receiving elements comprise tubes.

12. An apparatus according to claim 11, wherein said tubes span the full length of said band.

13. An apparatus according to claim 12, wherein said tubes protrude from said first and second open sides.

14. An apparatus according to claim 1, wherein said weight receiving elements are positioned at a substantial equal distance from one another.

15. An apparatus according to claim 1, wherein said weight receiving elements comprise tubes.

16. An apparatus according to claim 15, wherein said tubes comprise at least one open longitudinal end for receiving a respective balance weight.

17. An apparatus according to claim 15, wherein said balance weights comprise rods.

18. An apparatus according to claim 1, wherein said weight receiving elements and said balance weights comprise mutual fasteners.

19. An apparatus according to claim 18, wherein said weight receiving elements comprise tubes, said balance weights comprise rods, said tubes comprising an open end for receiving a respective rod, said tube comprising a removable cap at an opposite end thereof, said cap comprising a fastener to fastened to fastener receiving element at a longitudinal end of said rod adjacent said cap.

20. An rotatable tubular cylinder roll comprising:
an inner annular face; and
weight receiving tubes disposed on the inner face of the annular body for receiving balance weights,
wherein balance weights are selectively and removably mounted to said weight receiving tubes for balancing the cylinder roll during rotation thereof.

21. An rotatable tubular cylinder roll comprising:
an inner annular face;
an apparatus for balancing a rotatable tubular cylinder roll having an inner annular face, the apparatus comprising:
an annular body mounted within the cylinder roll and defining inner and outer faces, said outer face engaging the cylinder inner annular face; and weight receiving elements disposed on said inner face of said annular body for receiving balance weights,
wherein said balance weights are selectively and removably mounted to said apparatus for balancing the cylinder roll during rotation thereof.

22. A cylinder roll according to claim 21, wherein said annular body is outwardly biased thereby providing said outer face to sealingly engage said cylinder inner annular face.

23. A cylinder roll according to claim 22, wherein the size of said annular body is selectively modifiable between one position where it sealingly engages said cylinder inner annular face and another position where it disengages said cylinder inner annular face.

24. An apparatus according to claim 21, wherein said weight receiving elements and said balance weights comprise mutual fasteners.

25. An apparatus according to claim 21, wherein said weight receiving elements comprise tubes, said balance weights comprise rods.

26. A method for balancing a cylinder roll, said method comprising:
providing an outwardly and annularly biased body to securely engage the inner annular face of the cylinder roll; and
mounting balance weights to this body.
